(19) United States
(12) Patent Application Publication
(10) Pub. No.: US 2024/0154985 A1
(43) Pub. Date: May 9, 2024

(54) SYSTEMS AND METHODS FOR PREDICTING A PLATFORM SECURITY CONDITION

(71) Applicant: CloudBlue LLC, Irvine, CA (US)

(72) Inventors: Evgenii ANDRIUKHIN, Sofia (BG); Ilya KOSTYULIN, Barcelona (ES)

(21) Appl. No.: 17/980,336

(22) Filed: Nov. 3, 2022

(51) Int. Cl. H04L 9/40; H04L 41/22

(52) U.S. Cl. CPC H04L 63/1433; H04L 41/22; H04L 63/1416

(57) ABSTRACT

A system may be configured to evaluate a state or condition of a services' stack. Some embodiments may include: monitoring, via first, second, and third sets of security tools configured to generate first, second, and third vulnerability scores, respectively, source code, a base image, and a runtime environment of each of several microservices in a stack. Each of the tools may be selectable and may comprise at least one of a scanner or sensor configured to output historical data. And the microservices may operate with respect to a same business goal or set of rules. The method may further include: iteratively predicting, via a model, a security rating for the stack of microservices based on the first, second, and third scores; and determining, based on the predicted rating, an amount of resources needed for a security team to increase the security rating via implementation of the resources.

### TECHNICAL FIELD

The present disclosure generally relates to systems and methods for monitoring a stack of cloud services.

### BACKGROUND

Security attacks may dynamically occur with respect to one or more vulnerabilities, e.g., within computationally-feasible timing. For example, when one risk is resolved, another threat may arise substantially soon thereafter. It is increasingly more challenging for an application security (AppSec) team to fully evaluate the state of a cloud platform overall and resolve problems thereof, before users and/or business operations are negatively impacted.

AppSec may be measured as a value of performance and commonly used to help an organization define and evaluate how successful it is typically in terms of making progress towards its long-term organizational goals. Application vulnerabilities contribute to information technology (IT) risk. Being a factor of overall business risk, businesses often intend to reduce IT risk to zero.

Known monitoring tools and/or security utilities are unable to provide a complete overview of all ecosystems involving needs of an applications' platform. Such tools are limited, e.g., to evaluating only a current state. But security degradation (or enhancement) may only be detected and addressed after it has occurred in the system. A need has thus arisen for a proactive method capable of predicting a security value change.

### SUMMARY

Systems and methods are disclosed for determining at least one of an overall state of a global cloud security platform, a history of previous components, and a current component's state. Accordingly, one or more aspects of the present disclosure relate to a method for monitoring, via first, second, and third sets of security tools configured to generate first, second, and third vulnerability scores, respectively, (i) source code, (ii) a base image (BI), and (iii) a runtime environment of each of a plurality of microservices in a stack. Each of the tools may be selectable and may comprise at least one of a scanner or sensor configured to output historical data. And the microservices (e.g., of a cloud platform) may operate in a unified way. For example, the microservices may share a set of operations parameters, including a same set of business goals and/or rules. The method may further include: iteratively predicting, via a model, a security rating for the stack of microservices based on the first, second, and third scores; and determining, based on the predicted rating, an amount of resources needed for a security team to increase the security rating via implementation of the resources.

The method is implemented by a system comprising one or more hardware processors configured by machine-readable instructions and/or other components. The system comprises the one or more processors and other components or media, e.g., upon which machine-readable instructions may be executed. Implementations of any of the described techniques and architectures may include a method or process, an apparatus, a device, a machine, a system, or instructions stored on computer-readable storage device(s).

### BRIEF DESCRIPTION OF THE DRAWINGS

The details of particular implementations are set forth in the accompanying drawings and description below. Like reference numerals may refer to like elements throughout the specification. Other features will be apparent from the following description, including the drawings and claims. The drawings, though, are for the purposes of illustration and description only and are not intended as a definition of the limits of the disclosure.

FIG. 1 illustrates an example of a system in which a security state of a microservices stack is dynamically predicted, in accordance with one or more embodiments.

FIG. 2 illustrates aspects of a (e.g., containerized) software release to be evaluated, in accordance with one or more embodiments.

FIG. 3 illustrates an example of data usable by a base image scanning tool, in accordance with one or more embodiments.

FIG. 4 illustrates a vulnerabilities mapping from a quantitative score to a qualitative rating, in accordance with one or more embodiments.

FIG. 5 illustrates an example of data usable by an environment scanning tool, in accordance with one or more embodiments.

FIG. 6 illustrates a mismatch between vulnerability scores and an amount of vulnerabilities, in accordance with one or more embodiments.

FIGS. 7-8 illustrate examples of data usable by a source code scanning tool, in accordance with one or more embodiments.

FIG. 9 illustrates an example of weighted and forecasted values that may be predicted by one or more embodiments.

FIG. 10 illustrates an example in which an increase in vulnerabilities may necessitate application of a patch to maintain or reduce a vulnerability score, in accordance with one or more embodiments.

FIG. 11 illustrates a process for predicting the security state and for reporting thereof, in accordance with one or more embodiments.

### DETAILED DESCRIPTION

As used throughout this application, the word “may” is used in a permissive sense (i.e., meaning having the potential to), rather than the mandatory sense (i.e., meaning must). The words “include,” “including,” and “includes” and the like mean including, but not limited to. As used herein, the singular form of “a,” “an,” and “the” include plural references unless the context clearly dictates otherwise. As employed herein, the term “number” shall mean one or an integer greater than one (i.e., a plurality).

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other.

Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device.

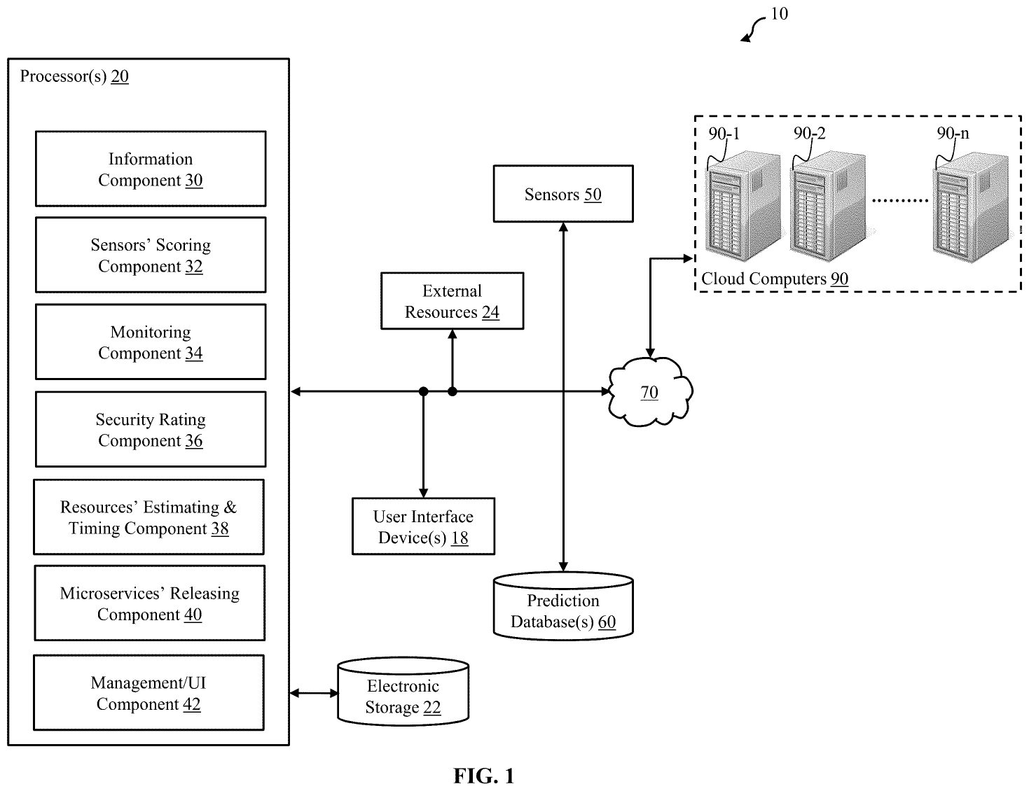

Presently disclosed are ways of creating a security score for a project using any number of security sensors. The sensors may be configured to output data in a particular way. For example, a release checklist may be created for each microservice on the cloud platform. The 3rd parties being liabilities, herein-contemplated reports may be more about the 3rd parties and may involve base image security and/or core review, etc., The report may be user-customizable (e.g., via UI devices 18 of FIG. 1). Using the security score, processors 20 of system 10 of FIG. 1 may be configured to determine a quantitative and/or qualitative effort required by a security team to implement, at least for maintaining or even for improving the current level of security or the security state of the project. For example, using a forecast module, processors 20 may be configured to estimate a possible security state for a subsequent release. In this or another example, system 10 may allow the security team to take appropriate measures proactively.

The herein-disclosed approach further improves upon any known, manual form of testing, which an AppSec team may consider with respect to behavior of each microservice and relations between them. For example, a possible business impact may be identified. But this way of testing relies on business logic error and cannot be easily automated.

Herein-contemplated microservices may comprise an architecture, structure, and/or style, having some aspects of a service-oriented architecture (SOA). These microservices may form a collection of loosely-coupled services, e.g., which may be fine-grained, have protocols that are lightweight (e.g., via containers), not impose their changes, and/or have reduced network communication requirements (e.g., to maintain the loose coupling). Each microservice may comprise a unique project from a developer's team, e.g., with respective development lifecycle, habits, and routines. A microservice may comprise 3 layers, including a microservice source code, source code dependencies (also known as 3rd parties), and a runtime environment.

In some embodiments, the microservices implemented at a plurality of cloud computers may be implemented using different programming languages, databases, hardware environments and software environments based on business and/or application needs, and/or serverless computing. With microservices, only the microservice supporting the function with resource constraints needs to be scaled up, thus providing resource and cost optimization benefits. The microservices may be independently deployable, having endpoints that may be logically coupled to other microservices to build a variety of applications.

The herein-disclosed approach allows an AppSec team to free up efforts otherwise used in manual testing. For example, manual testing is used in scenarios where an existing automatic tool falls short. As such, system 10 defines implementations where additional efforts and/or resources can be applied to fix one or more security issues identified by system 10.

The herein-disclosed approach further allows a measurement of one or more information technology (IT) risks and at least a brief estimation of how much effort may be needed to at least maintain the same component's security state. The herein-disclosed approach may further enable a consolidation of each of the components and/or a platform security state, e.g., in a single metric. In some embodiments, each microservices component and/or the platform security state may be consolidated in a single metric (e.g., for performing a simplification by summing or otherwise combining the individual microservices' scores).

System 10 is depicted in FIG. 1 to include processors 20 (having components discussed below), sensors 50 (discussed below), cloud computers 90 (e.g., 90-1, 90-2, . . . 90-n, n being a natural number), network 70, and peripheral structure for processors 20 (also discussed below). The herein-disclosed approach may be further expandable by design, e.g., with every security tool being considered as to whether it provides historical data and an application's current state. In a non-limiting example, a user may request a trigger into a microservices manager when a seasonality application detects a combined forecast (seasonal-based and trend-based), which may be above 90% CPU usage within the next hour. In one embodiment, the trigger, when satisfied, might output time-series data for consumption by a target microservice.

As shown in FIG. 1, processor 20 is configured via machine-readable instructions to execute one or more computer program components. The computer program components may comprise one or more of information component 30, sensors' scoring component 32, monitoring component 34, security rating component 36, resource estimating component 38, microservices' releasing component 40, management/UI component 42, and/or other components. Processor 20 may be configured to execute components 30, 32, 34, 36, 38, 40, and/or 42 by: software; hardware; firmware; some combination of software, hardware, and/or firmware; and/or other mechanisms for configuring processing capabilities on processor 20.

It should be appreciated that although components 30, 32, 34, 36, 38, 40, and 42 are illustrated in FIG. 1 as being co-located within a single processing unit, in embodiments in which processor 20 comprises multiple processing units, one or more of components 30, 32, 34, 36, 38, 40, and/or 42 may be located remotely from the other components. For example, in some embodiments, each of processor components 30, 32, 34, 36, 38, 40, and 42 may comprise a separate and distinct set of processors. The description of the functionality provided by the different components 30, 32, 34, 36, 38, 40, and/or 42 described below is for illustrative purposes, and is not intended to be limiting, as any of components 30, 32, 34, 36, 38, 40, and/or 42 may provide more or less functionality than is described. For example, one or more of components 30, 32, 34, 36, 38, 40, and/or 42 may be eliminated, and some or all of its functionality may be provided by other components 30, 32, 34, 36, 38, 40, and/or 42. As another example, processor 20 may be configured to execute one or more additional components that may perform some or all of the functionality attributed below to one of components 30, 32, 34, 36, 38, 40, and/or 42.

Everyday there are at least a few vulnerabilities that affect a (e.g., cloud) platform, it being nearly impossible to reach a zero-vulnerability metric. For example, the time required to apply a patch often is greater than the time to discover a new vulnerability in a piece of software or technology that forms a component itself. Vulnerability reduction, though, is not the same as risk reduction. Found vulnerabilities, e.g., in 3rd party dependencies or in one or more microservice source code dependencies, may each have a different criticality level and impact on the component, e.g., compared to a vulnerability found manually.

Vulnerabilities found manually may not be associated with a platform component but rather may be speculations on legitimate functionality of the platform. Some embodiments may thus reduce or eliminate a need for automatic scanning reviews. Fixing (e.g., via a determined amount of resources and/or at a certain time) 1,000 critical vulnerabilities associated with third party source code responsive to a report by one or more scanners 50 may (e.g., automatically) adjust a risk level relative to fixing one critical vulnerability found manually. Each microservice or utility may have its own vulnerability profile and/or database associated with it, e.g., including an individual set of type 1 (false positive) and type 2 (false negative) errors. In some embodiments, monitoring component 34 may individually monitor the respective profile and/or database, and security rating component 36 may generate a unified metric, e.g., for overviewing the application state without considering the source of the information. For example, only historical data and a current state snapshot may be needed.

The herein-disclosed approach may reduce an IT risk level to an acceptable level over time and/or highlight a trend to developers or auditors, e.g., by predicting when to reserve and when a need will be for a resource-based effort. For example, these options may comprise: updating core image, updating core image components, updating 3rd parties, removing 3rd parties, replacing 3rd parties, disabling code endpoints, adding new layers of protection for endpoints (e.g., input data sanitizers), and/or another suitable option.

Different types of microservices may be integrated or otherwise form part of a stack (e.g., unified via a same business set of goals and/or rules). In some embodiments, monitoring component 34 may analyze code, a base image, and the environment of each microservice of the stack. For example, monitoring component 34 may obtain and store historical data, e.g., via a plurality of predetermined tools, such as (but not limited to) Anchore®/Trivy® (e.g., for base image (BI) vulnerability check(s)), DTRACK (e.g., for environment vulnerability check(s)), Sonar® (e.g., for source code vulnerability check(s)), and/or another image, environment, and/or code scanner.

In some embodiments, the historical data may be displayed (e.g., via UI devices 18) to a user of system 10.

In this or another example, outputs of those tools or instruments may be combined. Each tool included in prediction database 60 that is used as a data source by monitoring component 34 may be required to provide at least one of a list of security vulnerabilities or a vulnerability score (or string, which may be transformed to a score) for each vulnerability from the list. Optionally, a vulnerability score transformer (e.g., EPSS) may instead or additionally be required.

Contemplated analysis of at least one sensor 50 (e.g., with a score calculated thereof) may involve a runtime environment and/or a runtime system, the latter of which may exemplarily be a gateway through which a running program interacts with the runtime environment. Said environment may comprise sub-system(s) that exist both in the computer where a program is created as well as in the computers where the program is intended to be run or executed. A stack of microservices may be an exemplary environment. The runtime system or environment may comprise managed structure (e.g., application memory, operating system interfacing, etc.).

The runtime environment may comprise state values and/or active entities, with which the program may interact during execution. For example, environment variables, being OS features, may be part of the runtime environment; and a running program may access them via the runtime system. Execution models can be implemented at least in part in a runtime system, which may be attributable to a program itself. Programming languages include a runtime system (e.g., including functionality for support services such as type checking, debugging, or code generation and optimization).

In some embodiments, security rating component 36 may predict a short-term security rating, requirements for the next platform release being known; and for next releases, the requirements may differ, and such prediction model may not then be needed. Such prediction model, though, may be implemented for the long-term, e.g., when required based on a historical factor and current dynamics.

In some embodiments, security rating component 36 may frequently, wholistically, and/or iteratively predict or forecast a security condition or risk level for a stack of microservices continuously (e.g., over an indefinite time). The frequency of the predictions may be tuned to be performed daily or at another regular and/or configurable interval. For example, several coefficients may be recalculated each time (e.g., on the backend in less time than the current period or need for the security rating), making it possible to be represented as a new state prediction of a current interval, time window, time lapse, or cycle. In a non-limiting example, a release of the stack may be at a tunable rate (e.g., every day, month, etc.) and/or when a security condition thereof is tasked for a checking.

In some embodiments, a user may be provided with an option to choose their depth of understanding into the algorithm itself (e.g., at the mathematical equation level or for explaining in a basis). For example, access to the algorithm may not be provided, but an ability to change the coefficients of the Holt-Winters model may be enabled.

In some embodiments, responsive to sensors' scoring component 32 obtaining historical data, monitoring component 34 may track a change to a project's state, according to its release life cycle. In these or other embodiments, each layer may individually and automatically apply additional checks, e.g., to exclude type 1 (false positive) errors; type 2 errors may be false negatives. For example, an exploit prediction scoring system (EPSS) score may be used at monitoring component 34 and/or security rating component 36. The scores may indicate respective probabilities that a software vulnerability will be exploited in deployment, and they may be used when prioritizing vulnerability remediation efforts. In an example, the higher the score, the greater the probability that a vulnerability will be exploited.

In some embodiments, results from sensors' scoring component 32 may be incomplete or unreliable as-is. For example, the resultant scores (or calculations thereabout) may need to be weighted, with some detected vulnerabilities being substantially minor and distracting. As such, disclosed embodiments may reduce the time spent with scanners 50, e.g., to increase the time spent hands-on working on the security team.

In some embodiments, monitoring component 34 and/or security rating component 36 may obtain a model from database 60 for predicting values (e.g., release points) for each microservice for at least one whole cycle. As described in detail below, in a non-limiting example, monitoring component 34 and/or security rating component 36 may obtain a Holt-Winters model from database 60 for predicting values (e.g., release points) for each microservice for at least one whole cycle. For example, there may be a significant increase of vulnerabilities over the cycle, but the predicted values may plummet soon after and exhibit an increasing trend thereafter (e.g., which may indicate a start of a new cycle). In this or another example, the component may not be contained (e.g., having previously been used, etc.), information being contemplated as calculated at system 10 by default.

In some embodiments, security rating component 36 and/or resource estimating component 38 may operate without excluding type 1 errors (i.e., false positive). For example, the possibility of missing or skipping a vulnerability may be eliminated by enriching data, using it to its higher potential. Rather than needlessly obtaining extraneous information, disclosed embodiments may obtain more information than would otherwise be necessary, e.g., to increase a number of false positives and to decrease a number of false negatives.

In some embodiments, monitoring component 34 and/or security rating component 36 may use a time series for detecting and subsequently alerting presence of an anomaly to developers.

In some embodiments, monitoring component 34 and/or security rating component 36 may obtain information for each season, timestamp, or another time period associated with a release cycle for all cloud microservices of cloud computer 90. For example, monitoring component 34 and/or security rating component 36 may synchronize or otherwise enrich the information for each microservice based on those that are already enriched. In this or another example, a component of processors 20 may measure all microservices of the stack using the available information (e.g., at information component 30), including where suitable information is currently missing for one or more of the microservices.

In an example, a component may be currently or recently released, e.g., with security rating component 36 being aware of a vulnerability thereat. But this knowledge may be spread among all the projects, e.g., as an integrated/individual pair of values. When this number increases, e.g., beyond a base level, resource estimating component 38 or microservices' releasing component 40 may generate and/or transmit a report (e.g., which may notify a need to review the situation). A manual score may then be decreased because the forecast may not be relevant or for another suitable reason. In some embodiments, additional scanning by sensors 50 may be implemented to force collected information to be further enriched to fix the variable. By thus obtaining updated information that otherwise would not have been collected, the estimated value of resources (e.g., man-hours) may be reduced.

In some embodiments, security rating component 36 may determine a security rating by summing security scores or values for each project or thread (e.g., related to outputs of one or more sensors 50 for each microservice at a particular time).

In some embodiments, when a security score satisfies a criterion (e.g., too high), developers may be triggered to provide a new release. A new, resultant security score may then differ (e.g., be less) from that previous security score. Application of a security patch may thus be recommended. In some embodiments, sensors' scoring component 32, monitoring component 34, and/or security rating component 36 may measure a possible security value, including by following some boundaries. For example, were a project security score to be greater than 50, then management/UI component 42 may communicate with the developers to determine what the work would be and how the work would resolve an issue.

In some embodiments, the security score or representative value calculated by security rating component 36 may be intended to be reduced. For example, resource estimating component 38 and/or microservices' releasing component 40 may perform (e.g., with a configured goal) to reduce an amount of human hours needed to rectify one or more vulnerabilities of the microservices' stack (e.g., implemented at cloud computers 90). In this or another example, a component of processors 20 may be configured to adjust a time when resources are needed to perform the rectification and/or address another security liability relevant to one or more microservices of the stack. And in any of these or another example, resource estimating component 38 and/or microservices' releasing component 40 may be involved in determining which task or project should be performed with a higher priority to better address the security goal(s). In this determination, these component(s) may further determine whether it is safe to delay implementation of certain resources for a lower priority security task, e.g., without substantially increasing a risk of a system crash or nefarious exploit.

In some embodiments, resource estimating component 38 and/or microservices' releasing component 40 may be configured to determine that a particular resource (e.g., human security specialist and/or software tool) is needed at a particular time, allowing a scheduling of the security team to be sufficiently staffed and/or otherwise prepared to resolve a problem predicted by security rating component 36.

In some embodiments, resource estimating component 38 may be more proactive, by allowing an amount of effort needed to put into an application (e.g., to at least stop a security rating from degrading and/or to increase said rating).

In some embodiments, resource estimating component 38 and/or microservices' releasing component 40 may obtain security scores (e.g., generated by component 36 and/or by sensors' scoring component 32), e.g., when communicating with one or more teams of developers. For example, scores, forecast(s), and/or a rating breaching a threshold may trigger a project measurement report.

In some embodiments, microservices' releasing component 40 may be involved in several, incremental releases, e.g., such that a security condition improves responsive to an adjustment to one or more of the microservices. In these or other embodiments, a risk level involving monitoring component 34 and/or security rating component 36 may be (e.g., user) configurable.

In some embodiments, the AppSec team and/or developers may determine the security level based on a set of documents (e.g., standards) governing how it is to be followed. For example, the stricter the requirements of said set of documents, the lower the security score may be.

In some embodiments, resource estimating component 38 may make a prediction such that the security rating determined by component 36 is lowered. For example, the AppSec team may be triggered to respond based on a security level being breached, and/or developers may be triggered to respond based on another security level being breached, to one or more vulnerabilities before the moment at which a risk materializes. In this or another example, the AppSec team may be triggered for involvement early on, resulting in a more secure outcome rather than obtaining the score when it may be too late for the security team to provide a patch or other remedy.

In some embodiments, management/UI component 42 or another component of system 10 may be configured to provide selectable sets (e.g., in a table via UI device 18) of components and/or microservices requested by a user. Once one or more of these sets are selected, monitoring component 34 may then be configured to begin one or more evaluations thereof to determine an overall score for a next release of microservices' stack 90.

In some embodiments, monitoring component 34 may determine that not all of the microservices have an update or a change, but the overall score (i.e., for all of the microservices involved and/or selected by a user) may then need to be recalculated. For example, a component or analyzer tool may not have had any updates in months, but other ones may be updated on a weekly basis. Fixing vulnerabilities in just the recently updated ones may be insufficient because, by not changing or updating the non-recently updated components of stack 90, the number of vulnerabilities may continue to grow.

Known security tools may create a snapshot of their current state, but only when compiling or otherwise preparing the product (e.g., for delivery). Thus, contrary to that approach wherein sensors are simply not triggered to collect information, sensors' scoring component 32 may communicate with sensors 50 associated with these tools, e.g., to cause triggers for collecting data from them about relevant operations and then to generate a report thereof. And monitoring component 34 may eliminate blind spots in visibility into a situation around this component. For example, monitoring component 34 and/or security rating component 36 may identify one or more trends (e.g., of behavior of another component), with the number of liabilities growing. The growth of vulnerabilities viciously feeds a feedback-driven-link on the backend of the component. In some embodiments, security rating component 36 may estimate a value or security score for the component that describes the situation (e.g., for a next day release).

In some embodiments, sensors or scanners 50 can include a tool or an application that collects data and responsively estimates. For example, information component 32 and/or sensors' scoring component 32 may obtain network data from security sensors 50 and create vulnerability notifications with respect to an attack (e.g., measurable with a high probability by monitoring component 34).

In some embodiments, management/UI component 42 may perform operations for deploying a platform via one or more configuration control files, including for forecasting a state of a stack of microservices. For example, this component may enable provision for all components that each provide collectable output data, and it may synchronize them on the backend. As a result, user experience is not impacted by eliminating security vulnerability surprises due to the security rating calculated by component 36 being based on all relevant microservices. In this or another example, resource estimating component 38 may determine a technological effort amount, a type of resources, and/or a time to implement the effort.

Each microservice release may be implemented according to a release quality checklist. For example, an AppSec team may check and determine a successful level or amount of security, e.g., having no predicted vulnerabilities; this approach may exclude manual testing. In this or another example, with respect to such layers as a microservice source code, source code dependencies, and a runtime environment, the vulnerabilities may have no security decreasing effect on the microservice.

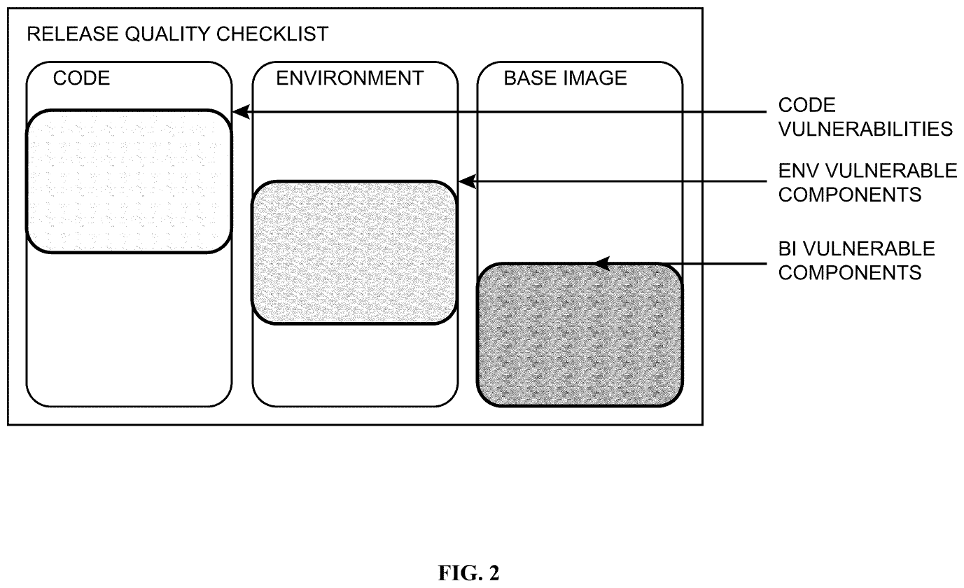

FIG. 2 illustrates aspects of a (e.g., containerized) software release to be evaluated, in accordance with one or more embodiments. As shown in the example of FIG. 2, each microservice tool (e.g., which may operate using sensors' scoring component 32) may focus on the security of one such layer 99 (e.g., code 99-1, environment 99-2, . . . and/or dependencies 99-n, n being any natural number), and it may provide at least a current application state for subsequent analysis. In some embodiments, when developing an appropriate coding and configuration model (e.g., a fuzzer for an application), another layer may be added to contribute to an automatic Java Bytecode security review. In some embodiments, the application can be based on a SpringBoot application framework.

In some embodiments, the tools implemented by sensors 50 may differ in use cases due to preferences and/or requirements of the relevant AppSec team and due to continuous integration (CI), which may form part of a continuous development/delivery (CD) process. As such, the components of processor 20 may be configured to interoperate with any set of security sensors 50 that output any (e.g., having much depth) amount of data. And functionality of the third parties may encapsulate one another, e.g., covering the functionality or source code from each of them. As a result, the security rating calculated by component 36 and an output from resource estimating component 38 may be more accurate and/or precise.

By monitoring component 34 relying on scores of three different sensors and by component 36 proactively predicting therefrom, the resultant security rating may be, e.g., more accurate and/or precise. Contemplated technology for system 10 may thus not be improved merely by using exploit prediction scoring system (EPSS) and common vulnerability scoring system (CVSS), but rather the way values from sensors 50 are recalculated.

As mentioned, a fuzzing technique may be used, e.g., for APIs to measure a security level. The fuzzing results may be treated as some data that may be mapped onto (e.g., predetermined) requirements. Since fuzzing results may be used to construct, they may be used as an additional layer. That is, the tool may not be contemplated in an implementation for checking a base image, environment, or source code vulnerability, but rather as an additional aspect or layer.

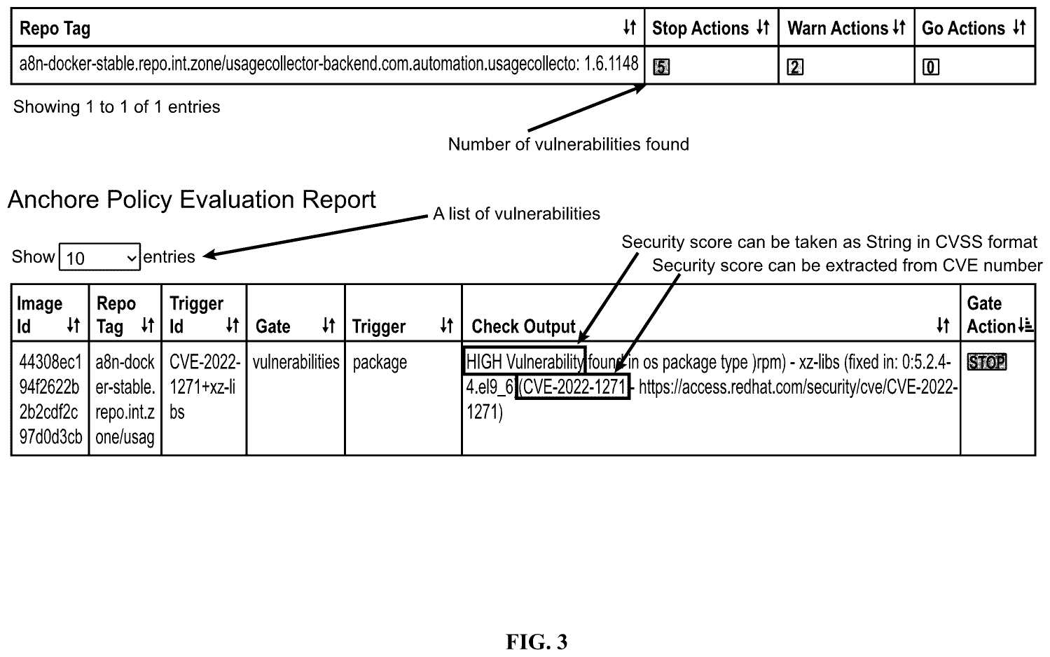

FIG. 3 illustrates an example of data usable by a base image scanning tool. In an example, SysDig may be used as a BI review tool. In another example, Anchore may be used as a BI review tool, e.g., which may provide all required data as shown in FIG. 3.

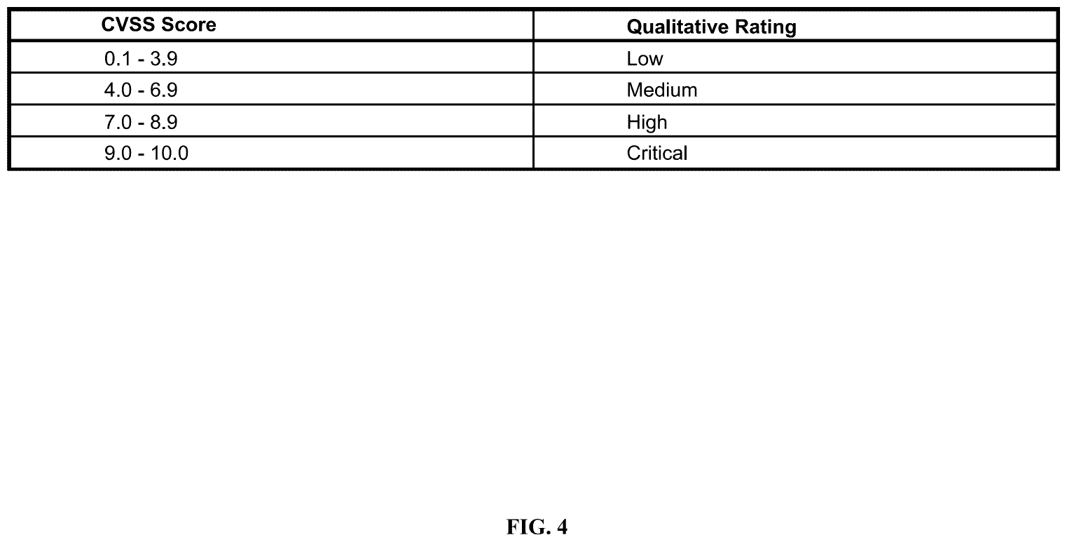

FIG. 4 illustrates a vulnerabilities mapping from a quantitative score to a qualitative rating. An example of a sensor-based vulnerability reporting tool is Anchore. For example, letting P be a Anchore project with m vulnerabilities, Anchore may not be able to provide numbers for the vulnerabilities. For each vulnerability D, CVSS_{D} metrics may be used and mapped, as shown in FIG. 4. A total Anchore project score may be characterized as: AS_{P}=Σᵢ₌₁^{m} CVSS_{D}_{ₘ}.

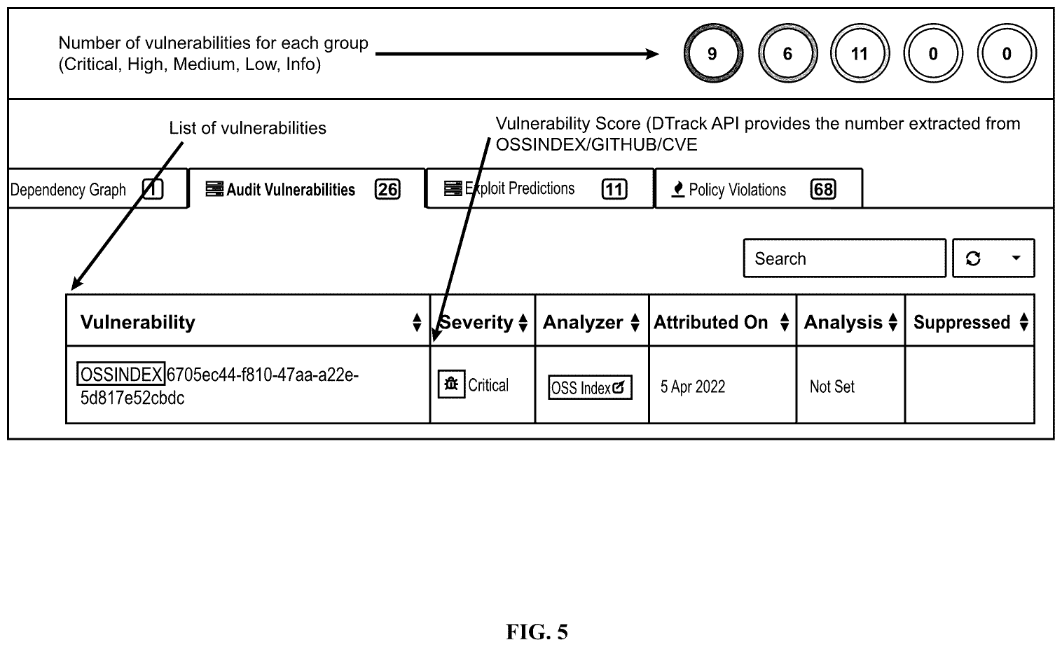

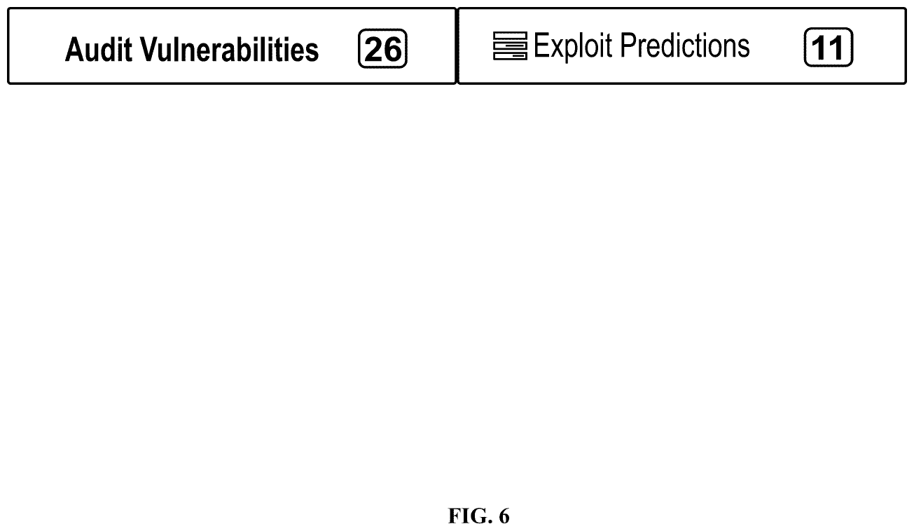

FIG. 5 illustrates an example of data usable by an environment scanning tool. DTrack may be an example of an environment review tool, e.g., to provide all required data as shown in FIG. 5. DTrack may also provide a vulnerability number transformer—EPSS score. As depicted in the example of FIG. 6, the number of EPSS scores available for the vulnerability check may not match the number of vulnerabilities. FIG. 6 illustrates a mismatch between vulnerability scores and an amount of vulnerabilities.

In some embodiments, sensors' scoring component 32 may implement a transformer, e.g., for converting a sensor's score into an EPSS or a value similar. For example, deep nested vulnerabilities may actually be determined (e.g., via DTrack) to have a lower level of danger than originally or previously estimated. And this may be targeted across the release. DTrack or another tool may not show two or more nested ones, but it may detect vulnerabilities in them. For example, a critical vulnerability (e.g., having an increased chance to be critically hit) may be detected. This may be yet another layer of dependency.

The herein-disclosed approach may resolve a misunderstanding, e.g., by providing additional nesting information and/or by providing an EPSS value, when the common vulnerabilities and exposures (CVE) does not have any.

In some embodiments, a component or microservice may be configured to read its JSON file. In some instances, though, converting the JSON into HTML may not be implemented, enabling use of a particular dependency added to the source code from third parties. This third party may, e.g., convert the JSON into the HTML file as required. One or more dependencies, being internal to each microservice, may involve a security risk and/or other vulnerability. A component of a microservice may be considered the third party.

In an example, letting P be a DTrack Project with n dependencies D. A DTrack EPSS dependency score ES_{D} may be a dependency score multiplied by EPSS vulnerability scores, e.g., as EPSS_{D}:ES_{D}=D*EPSS_{D}. If the dependency does not have a relevant EPSS_{D}, CVSS_{D} metrics may be used (e.g., which may be mapped as follows or in other values according to experience), as shown in FIG. 4.

For dependencies without EPSS_{D} value DTrack may provide a CVSS_{D} string. For each range, a worst-case scenario may be estimated. For example, nothing may feasibly be done with the project in that scenario. And, in another example or scenario, a medium vulnerability may be resolved into CVSS_{D}=0.69 or other value based on experience.

In an example, letting P have k vulnerabilities with an EPSS_{D} value and l vulnerabilities having a CVSS_{D} score. A DTrack EPSS project score ES_{P} may be a sum of all dependencies scores multiplied by an EPSS dependency score, as: EPSS_{D}: ES_{P}=Σᵢ₌₀^{k}ES_{D}=Σᵢ₌₀^{k}Dᵢ*EPSS_{D}_{ᵢ}.

In an example, P may be given a vulnerability found in the component nested on m layer of dependencies. A nested dependency score DS_{D}_{ₘ} may be a multiplication of a CVSS dependency score with 1/m depth value:

$$D {S}_{{D}_{m}} = \frac{1}{m} * C V S {S}_{D} .$$

And a nested dependency project score DS_{P} may be a sum of all nested dependency scores, as: DS_{P}=Σᵢ₌₀^{l}DS_{D}_{ᵢ}.

A total DTrack project score TSₚ score may be a sum of a nested dependency score and a DTrack EPSS project score, as: TSₚ=DS_{P}+ES_{P}.

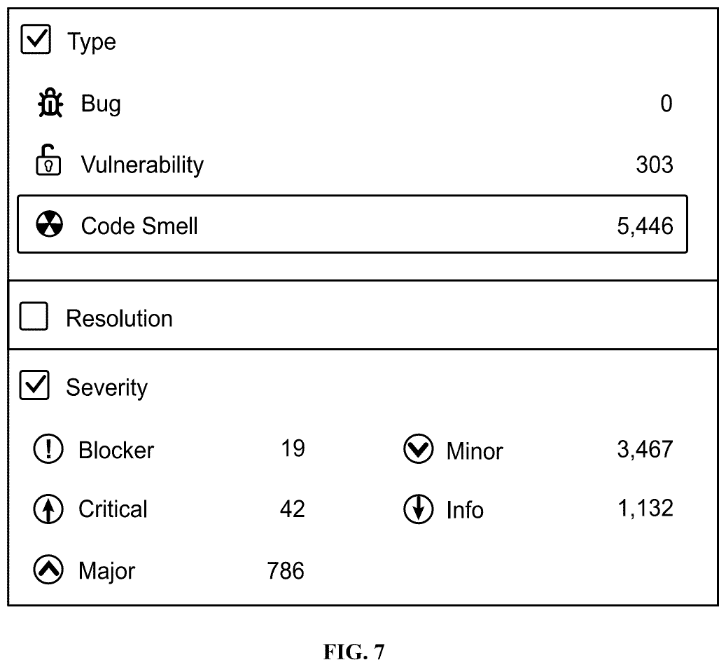

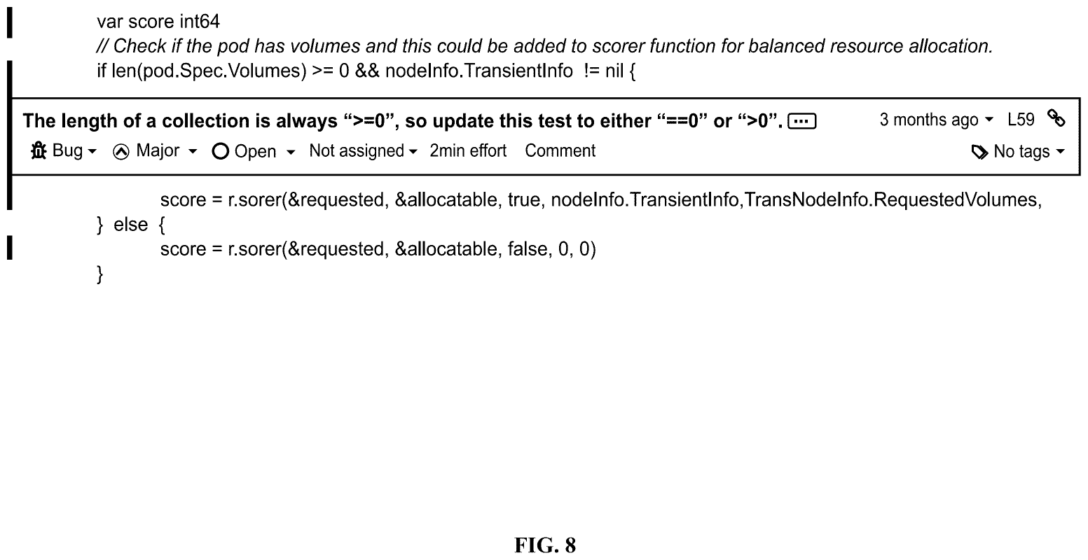

In an example, ShiftLeft may be used for source code vulnerability checking. In another example, Sonar may be used as a static code review tool, e.g., for providing all required data as shown in FIGS. 7-8. FIGS. 7-8 illustrate examples of data usable by a source code scanning tool.

In an example, a sonar dashboard may include a list of vulnerabilities, e.g., including the severity value for each of them. Even though the name for the severities may differ from the ones in CVSS, these values may be the same on the backend. In this or another example, Blocker may relate to Critical, and Critical may relate to High, etc. P may be given a Sonar project with m vulnerabilities. Sonar may not provide numbers for the vulnerabilities. Thus, for each vulnerability D, CVSS_{D} metrics may be used, which may be mapped as in the example of FIG. 4. Then, a total sonar project score may be, as: SS_{P}=Σᵢ₌₁^{m}CVSS_{D}_{ₘ}. The total project security score TPSS_{P} may be a sum of all independent tools scores for each of the layers, as: TPSSₚ=ASₚ+TSₚ+SSₚ.

Holt-Winters is a model of time series behavior, e.g., being a way to model three aspects of a time series. A first may be a typical value (average), a second may be the slope (trend) over time, and a third may be a cyclical repeating pattern (seasonality). In an example, release lifecycles being cyclical, the requirement of seasonality may be considered by default. In this or another example, estimations may be made about the slope, being at least the same as before. And an average value may be taken from historical project data as a mean value.

According to the model at every moment of time, the security value may be assumed as a sum of a basic (raw), slope, and seasonality values, e.g., with the seasonality value being associated with the slope. A seasonal component in the model may describe periodic changes around the slope, e.g., which may be characterized by a length of the season.

Since historical data for all layers may be defined and obtained by information component 30, security rating component 36 may implement a forecast method. Since the collected data may be related to a fixed time—in contrast to random data—it may contain additional, extractable information.

In some embodiments, a model of prediction database 60 may be based on, e.g., a Holt-Winters implementation, which may involve estimating the slope and determining the average or mean values. For example, a release cycle of the Holt-Winters model may comprise a time at which a product, component, or microservice (e.g., which may be fully functioning) is ready to be published. In this or another example, the slope may be enough to facilitate one or more peer requests from the customers and responsive fixes (e.g., there being associated dates).

In some embodiments, each season may comprise timing information, e.g., from a beginning until a moment when component(s) are cyclically released. In each exemplary cycle, the number of vulnerabilities may increase relatively over that time period, but it may decrease absolutely over several cycles. Since a release may be at the end of the cycle, that release date may involve a s project in its best condition. The worst security score among all releases may be a threshold, above which a project would be marked as “no go” in terms of release. That is, even though the security score of each cycle may be continuously increasing, it does not mean that it would reach the threshold in one, two, or N cycles. For example, a score of 50 may be had at the end of the cycle, but a score of 2 may be achieved at the beginning of the new cycle. During the cycle, the score may be increased up to 15. That is, a relative score +13 may be had, but an absolute score may be −35.

Starting from the naïve idea—where tomorrow is the same as yesterday—a reasonable assumption may be that the future depends on the median of n previous values. This is called a moving mean value and may be calculated as follows:

$${\hat{y}}_{t} = \frac{1}{k} {\sum }_{n = 0}^{k - 1} {y}_{t - n} .$$

A simple moving mean modification—weighted average—allows a more precise forecast via adding a weights parameter (a sum of weights is 1). The value may be calculated as follows: ŷₜ=Σₙ₌₁^{k}wₙyₜ₊₁₋ₙ.

The idea behind the Brown's model is to weight all available historical data, decreasing the weights value exponentially: ŷₜ=α*yₜ+(1−α)*ŷₜ₋₁. The model value may be a weighted mean among current and previous historical values. Weight a is a smoothing factor, e.g., defining how fast the last available historical value is forgotten. For example, by decreasing a the impact of the historical data on the forecast result may be increased. And by adding a value, only one forecast value may be created. For example, by being multiplied by the value of y from t, the value may be directly affected.

A model such as Holt's may be modified to allow a splitting of the series to two parts—level (l) and trend/slope (b). For example, a forecast value may be found, as: lₓ=α*yₓ+(1−α)*(lₓ₋₁+bₓ₋₁); bₓ=β*(lₓ−lₓ₋₁)+(1−β)*bₓ₋₁; and ŷₓ₊₁=lₓ+bₓ.

A first function (lₓ) may define a level, e.g., depending on the current value. But the value may split on the previous historical data value and trend. A second function (bₓ) may define a trend, e.g., depending on the current value level change and a previous trend value. β may be a new weight value for the weight function.

And then the model of database 60 may be modified again to implement a Holt-Winters model, e.g., by adding a new (e.g., seasonality) component. In some implementations, the season may be a software release cycle. Seasonal components may, e.g., explain a period around a trend and levels. Thus, a value may be forecasted, as: lₓ=α *(yₓ−s_{x-L})+(1−α)*(1ₓ₋₁+bₓ₋₁); bₓ=β*(lₓ−lₓ₋₁)+(1−β)*bₓ₋₁; sₓ=γ(yₓ−lₓ)+(1−γ)s_{x-L}; and ŷₓ₊ₘ=lₓ+mbₓ+s_{x-L+1+(m-1)modL}.

Coefficients α,β,γ may be calculated using time serial cross-validation. Historical data may have a time-based basis, and this dependency may be protected. Accordingly, some implementations may involve cross-validation on a rolling basis. In an example according to the model, at every moment of time the security value may be assumed as a sum of the basic (raw) value, slope value, and seasonality value. A seasonal component in the model may describe periodical changes around the slope and characterized by a length of the season.

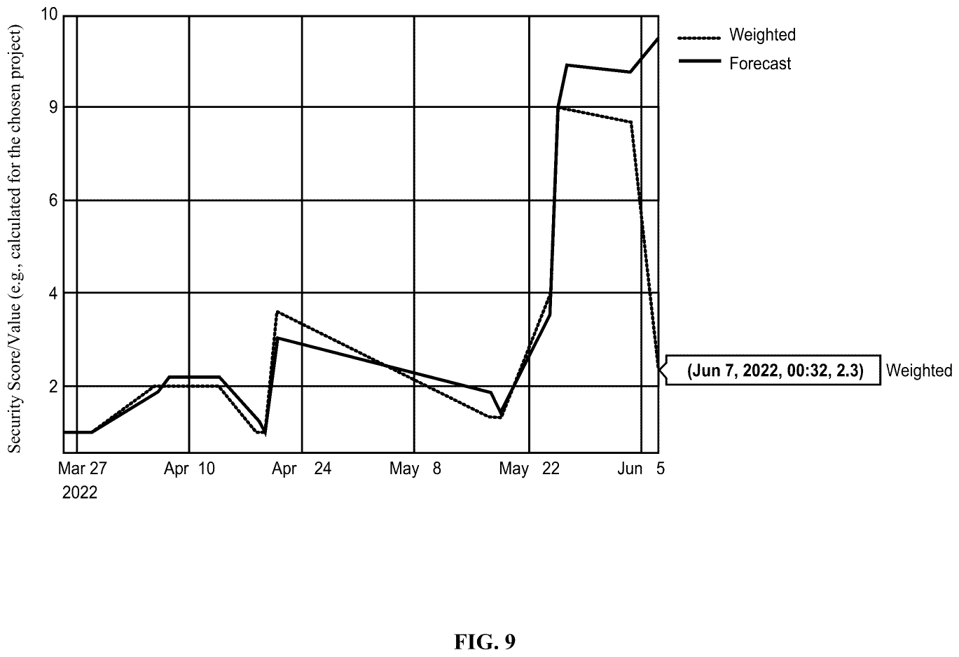

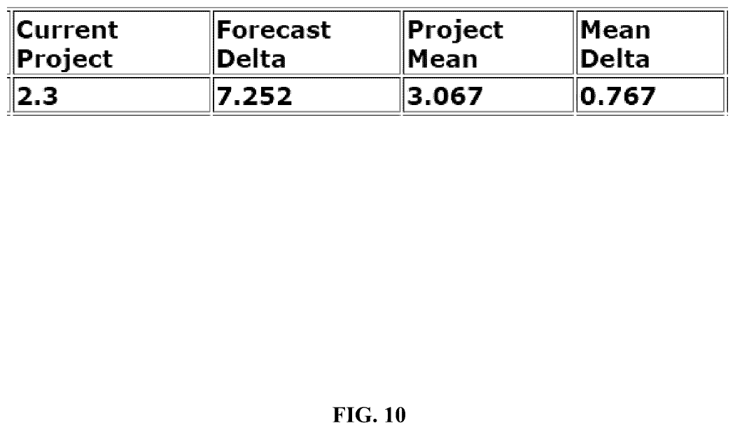

In some embodiments, an algorithmic Holt-Winters model may be implemented for short-term (i.e., for a next release) forecasting, e.g., to identify possibly-reachable security values by the application or microservice. For example, a new database on software releases may describe several, nested vulnerabilities in third party components. FIG. 9 depicts an example chart of a forecast in relation to the same when weighted, and FIG. 10 depicts information relative to a score-reducing-patch (e.g., which may be applied responsive to a detected increase in vulnerabilities). FIG. 10 depicts the example that, since a current project score may be 2.3 and a forecast value may be 7.52, more steps may be determined to not be necessary to secure the project. Since a project mean may be 3.0, the component may be acceptable, and it can be released because it is at least now worse than what may already be released. In other embodiments, monitoring component 34 and/or security rating component 36 may adjust the model (e.g., which may be obtained from prediction database 60), for one or more long-term predictions. A duration criterion fulfilled when monitoring to perform a short-term prediction may be greater than a length of time of each of the iterations.

In some embodiments, a set of coefficients may be determined using time-serial cross-validation on a rolling basis. For example, said cross-validation may involve, according to the model at every moment of time a security value is assumed as a sum of basic (raw) values, slope and seasonality values. The seasonality value may be associated to the slope value. A seasonal component in the model may describe periodical changes around the slope and may be characterized by a length of the season.

We also consider the value of project mean value because application degradation might happen to be a trend, so, the method will take this as a feature and would not alert us.

Electronic storage 22 of FIG. 1 comprises electronic storage media that electronically stores information. The electronic storage media of electronic storage 22 may comprise system storage that is provided integrally (i.e., substantially non-removable) with system 10 and/or removable storage that is removably connectable to system 10 via, for example, a port (e.g., a USB port, a firewire port, etc.) or a drive (e.g., a disk drive, etc.). Electronic storage 22 may be (in whole or in part) a separate component within system 10, or electronic storage 22 may be provided (in whole or in part) integrally with one or more other components of system 10 (e.g., a user interface (UI) device 18, processor 20, etc.). In some embodiments, electronic storage 22 may be located in a server together with processor 20, in a server that is part of external resources 24, in UI devices 18, and/or in other locations. Electronic storage 22 may comprise a memory controller and one or more of optically readable storage media (e.g., optical disks, etc.), magnetically readable storage media (e.g., magnetic tape, magnetic hard drive, etc.), electrical charge-based storage media (e.g., EPROM, RAM, etc.), solid-state storage media (e.g., flash drive, etc.), and/or other electronically readable storage media. Electronic storage 22 may store software algorithms, information obtained and/or determined by processor 20, information received via UI devices 18 and/or other external computing systems, information received from external resources 24, and/or other information that enables system 10 to function as described herein.

External resources 24 may include sources of information (e.g., databases, websites, etc.), external entities participating with system 10, one or more servers outside of system 10, a network, electronic storage, equipment related to Wi-Fi technology, equipment related to Bluetooth® technology, data entry devices, a power supply (e.g., battery powered or line-power connected, such as directly to 110 volts AC or indirectly via AC/DC conversion), a transmit/receive element (e.g., an antenna configured to transmit and/or receive wireless signals), a network interface controller (NIC), a display controller, a graphics processing unit (GPU), and/or other resources. In some implementations, some or all of the functionality attributed herein to external resources 24 may be provided by other components or resources included in system 10. Processor 20, external resources 24, UI device 18, electronic storage 22, a network, and/or other components of system 10 may be configured to communicate with each other via wired and/or wireless connections, such as a network (e.g., a local area network (LAN), the Internet, a wide area network (WAN), a radio access network (RAN), a public switched telephone network (PSTN), etc.), cellular technology (e.g., GSM, UMTS, LTE, 5G, etc.), Wi-Fi technology, another wireless communications link (e.g., radio frequency (RF), microwave, infrared (IR), ultraviolet (UV), visible light, cm wave, mm wave, etc.), a base station, and/or other resources.

UI device(s) 18 of system 10 may be configured to provide an interface between one or more users and system 10. In some embodiments, UI devices 18 can be configured to provide information to and/or receive information from the one or more users. UI devices 18 include a UI and/or other components. The UI may be and/or include a graphical UI configured to present views and/or fields configured to receive entry and/or selection with respect to particular functionality of system 10, and/or provide and/or receive other information. In some embodiments, the UI of UI devices 18 may include a plurality of separate interfaces associated with processors 20 and/or other components of system 10. Examples of interface devices suitable for inclusion in UI device 18 include a touch screen, a keypad, touch sensitive and/or physical buttons, switches, a keyboard, knobs, levers, a display, speakers, a microphone, an indicator light, an audible alarm, a printer, and/or other interface devices. The present disclosure also contemplates that UI devices 18 include a removable storage interface. In this example, information may be loaded into UI devices 18 from removable storage (e.g., a smart card, a flash drive, a removable disk) that enables users to customize the implementation of UI devices 18.

In some embodiments, UI devices 18 can be configured to provide a UI, processing capabilities, databases, and/or electronic storage to system 10. As such, UI devices 18 may include processors 20, electronic storage 22, external resources 24, and/or other components of system 10. In some embodiments, UI devices 18 can be connected to a network (e.g., the Internet). In some embodiments, UI devices 18 do not include processor 20, electronic storage 22, external resources 24, and/or other components of system 10, but instead communicate with these components via dedicated lines, a bus, a switch, network, or other communication means. The communication may be wireless or wired. In some embodiments, UI devices 18 can be laptops, desktop computers, smartphones, tablet computers, and/or other UI devices.

Data and content may be exchanged between the various components of the system 10 through a communication interface and communication paths using any one of a number of communications protocols. In one example, data may be exchanged employing a protocol used for communicating data across a packet-switched internetwork using, for example, the Internet Protocol Suite, also referred to as TCP/IP. The data and content may be delivered using datagrams (or packets) from the source host to the destination host solely based on their addresses. For this purpose the Internet Protocol (IP) defines addressing methods and structures for datagram encapsulation. Of course other protocols also may be used. Examples of an Internet protocol include Internet Protocol version 4 (IPv4) and Internet Protocol version 6 (TPv6).

In some embodiments, processor(s) 20 may form part (e.g., in a same or separate housing) of a user device, a consumer electronics device, a mobile phone, a smartphone, a personal data assistant, a digital tablet/pad computer, a wearable device (e.g., watch), augmented reality (AR) goggles, virtual reality (VR) goggles, a reflective display, a personal computer, a laptop computer, a notebook computer, a work station, a server, a high performance computer (HPC), a vehicle (e.g., embedded computer, such as in a dashboard or in front of a seated occupant of a car or plane), a game or entertainment system, a set-top-box, a monitor, a television (TV), a panel, a space craft, or any other device. In some embodiments, processor 20 is configured to provide information processing capabilities in system 10. Processor 20 may comprise one or more of a digital processor, an analog processor, a digital circuit designed to process information, an analog circuit designed to process information, a state machine, and/or other mechanisms for electronically processing information. Although processor 20 is shown in FIG. 1 as a single entity, this is for illustrative purposes only. In some embodiments, processor 20 may comprise a plurality of processing units. These processing units may be physically located within the same device (e.g., a server), or processor 20 may represent processing functionality of a plurality of devices operating in coordination (e.g., one or more servers, UI devices 18, devices that are part of external resources 24, electronic storage 22, and/or other devices).

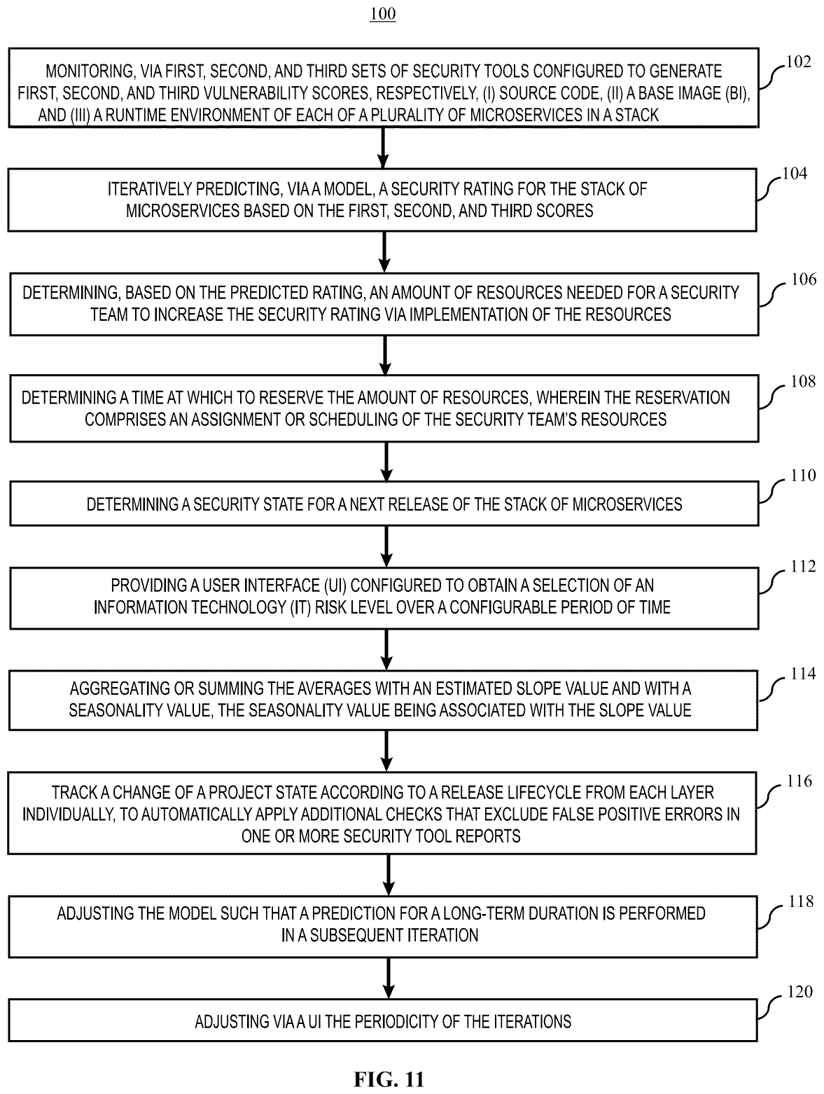

FIG. 11 illustrates method 100 for obtaining information for adjusting a platform security condition, in accordance with one or more embodiments. Method 100 may be performed with a computer system comprising one or more computer processors and/or other components. The processors can be configured by machine readable instructions to execute computer program components. The operations of method 100 presented below are intended to be illustrative. In some embodiments, method 100 may be accomplished with one or more additional operations not described, and/or without one or more of the operations discussed. Additionally, the order in which the operations of method 100 are illustrated in FIG. 11 and described below is not intended to be limiting. In some embodiments, method 100 may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of method 100 in response to instructions stored electronically on an electronic storage medium. The processing devices may include one or more devices configured through hardware, firmware, and/or software to be specifically designed for execution of one or more of the operations of method 100.

At operation 102 of method 100, (i) source code, (ii) a base image (BI), and (iii) a runtime environment of each of a plurality of microservices in a stack may be obtained and monitored, e.g., via first, second, and third sets of security tools configured to generate first, second, and third vulnerability scores, respectively. In some embodiments, operation 102 is performed by processor components the same as or similar to information component 30, sensors' scoring component 32, and monitoring component 34 (shown in FIG. 1 and described herein).

At operation 104 of method 100, a security rating for the stack of microservices may be iteratively predicted, e.g., via a model based on the first, second, and third scores. In some embodiments, operation 104 is performed by a processor component the same as or similar to security rating component 36 (shown in FIG. 1 and described herein). Security rating component 36 may neither detect intrusions nor react therefrom in real-time. In some embodiments, this component may thus instead track possible vulnerabilities. In some implementations, possible fixes for the situation may even be generated. For example, herein-contemplated operations may be rule-based and/or behavior-based (e.g., on the backend).

At operation 106 of method 100, an amount of resources needed for a security team, e.g., to increase the security rating via implementation of the resources, may be determined based on the predicted rating. In some embodiments, operation 106 is performed by a processor component the same as or similar to resource estimating component 38 (shown in FIG. 1 and described herein).

At operation 108 of method 100, a time at which to reserve the amount of resources may be determined. In some embodiments, operation 108 is performed by a processor component the same as or similar to resource estimating component 38 (shown in FIG. 1 and described herein).

At operation 110 of method 100, a security state for a next release of the stack of microservices may be determined. In some embodiments, operation 110 is performed by a processor component the same as or similar to microservices' releasing component 40 (shown in FIG. 1 and described herein).

At operation 112 of method 100, a UI configured to obtain a selection of an information technology f3) risk level over a configurable period of time may be provided. In some embodiments, operation 112 is performed by a processor component the same as or similar to management/UI component 42 (shown in FIG. 1 and described herein).

At operation 114 of method 100, the averages with an estimated slope value and with a seasonality value may be aggregated or summed, the seasonality value being associated with the slope value. In some embodiments, operation 114 is performed by processor component(s) the same as or similar to monitoring component 34 and/or security rating component 36.

At operation 116 of method 100, a change of a project state may be tracked according to a release lifecycle from each layer individually, e.g., to automatically apply additional checks that exclude false positive errors in one or more security tool reports. In some embodiments, operation 116 is performed by a processor component the same as or similar to monitoring component 34.

At operation 118 of method 100, the model may be adjusted such that a prediction for a long-term duration is performed, e.g., in a subsequent iteration. In some embodiments, operation 118 is performed by a processor component the same as or similar to management/UI component 42.

At operation 120 of method 100, the periodicity of the iterations may be adjusted via a UI. In some embodiments, operation 120 is performed by a processor component the same as or similar to management/UI component 42.

Techniques described herein may be implemented in digital electronic circuitry, or in computer hardware, firmware, software, or in combinations of them. The techniques may be implemented as a computer program product, i.e., a computer program tangibly embodied in an information carrier, e.g., in a machine-readable storage device, in machine-readable storage medium, in a computer-readable storage device or, in computer-readable storage medium for execution by, or to control the operation of, data processing apparatus, e.g., a programmable processor, a computer, or multiple computers. A computer program may be written in any form of programming language, including compiled or interpreted languages, and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network.

Method steps of the techniques may be performed by one or more programmable processors executing a computer program to perform functions of the techniques by operating on input data and generating output. Method steps may also be performed by, and apparatus of the techniques may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory may be supplemented by, or incorporated in special purpose logic circuitry.

Several embodiments of the disclosure are specifically illustrated and/or described herein. Modifications and variations are contemplated and within a purview of appended claims.

What is claimed is:

1. A computer-implemented method, comprising:
providing first, second, and third sets of security tools configured to generate first, second, and third vulnerability scores, respectively;
monitoring, via the first, second, and third sets of security tools, (i) source code, (ii) a base image (BI), and (iii) a runtime environment of each of a plurality of microservices in a stack, wherein each of the security tools is selectable and comprises at least one of a scanner or sensor configured to output historical data, and wherein the microservices operate with respect to a same set of operations parameters;
iteratively predicting, via a model, a security rating for the stack of microservices based on two or more of the first, second, and third scores; and
determining, based on the predicted rating, an amount of resources needed to enable a security team to increase security via implementation of the resources.

2. The method of claim 1, further comprising:
determining a time at which to implement a reservation of the amount of resources, the reservation comprising an assignment or scheduling of the security team's resources.

3. The method of claim 1, further comprising:
determining a security state for a next release of the stack of microservices.

4. The method of claim 1, wherein the microservices comprise one or more sets of cloud services.

5. The method of claim 1, further comprising:
providing a user interface (UI) configured to obtain a selection of an information technology (IT) risk level over a configurable period of time.

6. The method of claim 1, wherein each of the scores is an average.

7. The method of claim 6, further comprising:
aggregating or summing the averages with an estimated slope value and with a seasonality value associated with the slope value.

8. The method of claim 1, wherein each of the iterative predictions is performed within a first duration, the first duration being greater than a length of time of each of the iterations, the iterations being periodic.

9. The method of claim 8, wherein each of the first and second durations is configurable via the UI.

10. The method of claim 1, further comprising:
transmitting a notification based on the determination, wherein the amount of resources is determined based on the security rating satisfying a first criterion, and
wherein the notification enables a team of developers to be activated when, at a subsequent iteration, the security rating is predicted to satisfy a second criterion having a greater risk level than the first criterion.

11. The method of claim 1, wherein each of the predictions is performed to enable a first amount of false positives to increase and a second amount of false negatives to decrease.

12. The method of claim 1, further comprising:
tracking a change of a project state according to a release lifecycle from each layer individually, to automatically apply additional checks that exclude false positive errors in one or more security tool reports.

13. The method of claim 8, further comprising:
adjusting the model such that a prediction for a long-term duration is performed in a subsequent iteration, the model being a Holt-Winters model.

14. The method of claim 1, further comprising:
adjusting via a UI the periodicity of the iterations.

15. A system, comprising: a memory having computer-readable instructions stored therein; and a processor configured to:
provide first, second, and third sets of security tools configured to generate first, second, and third vulnerability scores, respectively;
monitor, the via first, second, and third sets of security tools, (i) source code, (ii) a base image (BI), and (iii) a runtime environment of each of a plurality of microservices in a stack, wherein each of the security tools is selectable and comprises at least one of a scanner or sensor configured to output historical data, and wherein the microservices operate with respect to a same set of operations parameters;
iteratively predict, via a model, a security rating for the stack of microservices based on two or more of the first, second, and third scores; and
determine, based on the predicted rating, an amount of resources needed to enable a security team to increase security via implementation of the resources.

16. The system of claim 15, wherein the processor is further configured to:
determine a time at which to implement a reservation of the amount of resources, the reservation comprising an assignment or scheduling of the security team's resources.

17. The system of claim 15, wherein the processor is further configured to:
determine a security state for a next release of the stack of microservices.

18. The system of claim 15, wherein the microservices comprise one or more sets of cloud services.

19. The system of claim 15, wherein the processor is further configured to:
provide a user interface (UI) configured to obtain a selection of an information technology (IT) risk level over a configurable period of time.

20. The system of claim 15, wherein the processor is further configured to:
aggregate or sum averages with an estimated slope value and with a seasonality value, the seasonality value being associated with the slope value,
wherein each of the scores is one of the averages.
